(19) United States
(12) Patent Application Publication
(10) Pub. No.: US 2017/0235905 A1
(43) Pub. Date: Aug. 17, 2017

(54) Telemedicine Data and Video Management System

(71) Applicant: Hector L. Santiago, JR., Kennesaw, GA (US)

(72) Inventor: Hector L. Santiago, JR., Kennesaw, GA (US)

(73) Assignee: REACH Health, Inc., Alpharetta, GA (US)

(21) Appl. No.: 15/043,839

(22) Filed: Feb. 15, 2016

(51) Int. Cl. G06F 19/00

(52) U.S. Cl. CPC G06F 19/3418; G06F 19/322; G06F 19/345

(57) ABSTRACT

A telemedicine system includes a patient treatment unit, a provider unit that is in a location remote from the patient treatment unit, and a server in communication with the global computer network. An application interface is configured to effect a peer-to-peer communication protocol between the patient treatment unit and the provider unit. Patient video from the patient treatment unit is transferred to the first provider unit and is displayed. Data from a patient sensor interface is also transferred to the provider unit. The application interface displays a widget on the provider unit monitor that is superimposed on the patient video and is semitransparent so that the patient video is viewable through the widget. At least one data value is displayed in the widget and visually contrasts with the video. The application interface also transmits data from the patient treatment computer to the server for storage by the server.

### BACKGROUND OF THE INVENTION

1. Field of the Invention

The present invention relates to telemedicine systems and, more specifically, to a telemedicine with an intuitively designed data display.

2. Description of the Related Art

Telemedicine exchanges medical information between a patient treatment unit and a provider unit via electronic communications. Telemedicine systems employ a variety of applications such as two-way video, email, smart phones, electronic data transfer and audio telecommunications. In a typical telemedicine system, a physician is located at a site that is remote from a patient. The patient might be at a remote patient treatment unit that is staffed by medical personnel, such as non-specialist physicians, physician assistants and nurses. A video camera/microphone system is trained on the patient so that the physician at the remote site can observe and communicate with the patient. Medical data sensors (such as vital signs sensors, EKG sensors, EEG sensors, etc.) can also be connected to the patient and feed data to the physician at the remote site. Based on observation and information, the physician at the remote site can then instruct personnel at the treatment unit regarding patient treatment.

Telemedicine facilitates treatment of a patient who is geographically separated from the treating physician or other healthcare provider. Telemedicine can be especially useful in situations in which a patient can benefit from immediate treatment from a specialist who is not located near the patient. For example, when a patient at a rural hospital shows stroke symptoms and when the local physician needs to consult with a neurologist from a larger medical center regarding immediate care of the patient, the local physician can employ telemedicine to connect the patient to the neurologist. The neurologist can observe the patient, ask questions of the patient and the local physician, and then prescribe an immediate course of treatment for the patient. This quick action can result in an improved prognosis for the patient.

Typical telemedicine systems employ a communications system in which data is sent from either the patient site or the provider unit to a server. The server then communicates the data to all stations. This method of communicating data can introduce an undesirable delay in the treatment process. Also, typical systems display video and data in separate windows or different sections of a display. As a result, a physician will have to choose between seeing a small representation of the video along with the data or seeing the full video without seeing the data.

Therefore, there is a need for a telemedicine system that communicates data between stations with minimal delay.

Therefore, there is also a need for a telemedicine system that allows a physician to view patient data while also being able to view a large format of the patient video.

### SUMMARY OF THE INVENTION

The disadvantages of the prior art are overcome by the present invention which, in one aspect, is a telemedicine system that includes a patient treatment unit, a first provider unit and a server. The patient treatment unit includes: a patient treatment computer in communication with a global computer network; a video camera in communication with the patient treatment computer; a patient sensor interface in communication with the patient treatment computer in which the patient sensor interface is configured to receive data from at least one patient sensor; a microphone in communication with the patient treatment computer; and a speaker in communication with the patient treatment computer. The first provider unit is in a location remote from the patient treatment unit and includes: a provider computer in communication with the global computer network; at least one microphone in communication with the provider computer; and a monitor in communication with the provider computer. The server is in communication with the global computer network. An application interface is configured to effect a peer-to-peer communication protocol between the patient treatment computer and the provider computer via the global computer network, in which patient video from the patient treatment unit is transferred to the first provider unit via the peer-to-peer communication protocol and displayed on the first provider unit monitor, and wherein data from the patient sensor interface is also transferred to the first provider unit via the peer-to-peer communication protocol, the application interface also configured to display a widget on the first provider unit monitor so as to be superimposed on the patient video so as to be semitransparent such that a portion of the patient video is viewable through a portion of the widget and such that at least one data value displayed in the widget visually contrast with the portion of the patient video under the widget wherein the widget includes patient-specific information and in which the application interface is configured to transmit the data from the patient treatment computer to the server for storage by the server.

In another aspect, the invention is a method of displaying information in a telemedicine system that communicates information between a patient treatment unit, a server and a provider unit having a monitor, in which video and patient-specific data are received from the patient treatment unit at the provider unit. The video is displayed on the provider unit monitor. The patient-specific data is displayed in a semi-transparent widget that overlays the video so that the video can be seen through at least a portion of the semi-transparent widget.

In yet another aspect, the invention is a method for communicating data in a telemedicine system that includes a patient treatment unit in communication with a global computer network, a provider unit in communication with the global computer network and a server in communication with the global computer network, in which a patient-specific datum is transmitted from the patient treatment unit to the provider unit via a peer-to-peer protocol. After transmitting the patient-specific datum to the first provider unit, the patient-specific datum is transmitted to the server. After transmitting the patient-specific datum to the server, the patient-specific datum is stored at the server and a persisted data indicator is transmitted from the patient treatment unit to the provider unit via the peer-to-peer protocol. After the provider unit receives the persisted data indicator, a stored data request is transmitted from the provider unit to the server. After the patient-specific datum has been stored by the server, a stored data confirmation is transmitted from the server to the provider unit and the datum is displayed with a stored data indicia on the display at the provider unit.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a schematic diagram of one embodiment of a telemedicine system.

FIG. 1B is a schematic diagram of one embodiment of a telemedicine system involving multiple providers.

FIG. 2A is a schematic diagram of a patient treatment unit at a patient treatment unit.

FIG. 2B is a schematic diagram of a first provider unit at a provider unit.

FIG. 3 is a timing diagram demonstrating a patient data communication protocol.

FIG. 4 is a representative dashboard display.

FIGS. 5A-5G are several representative treatment video displays each with at least one widget overlaying a patient video stream.

FIG. 6 is a representative video display with a diagnostic scoring test pull down overlaying a patient video stream.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet. Also, as used herein, “widget” means a visually-perceptible object that displays data within a portion of, but not all of, a computer video display.

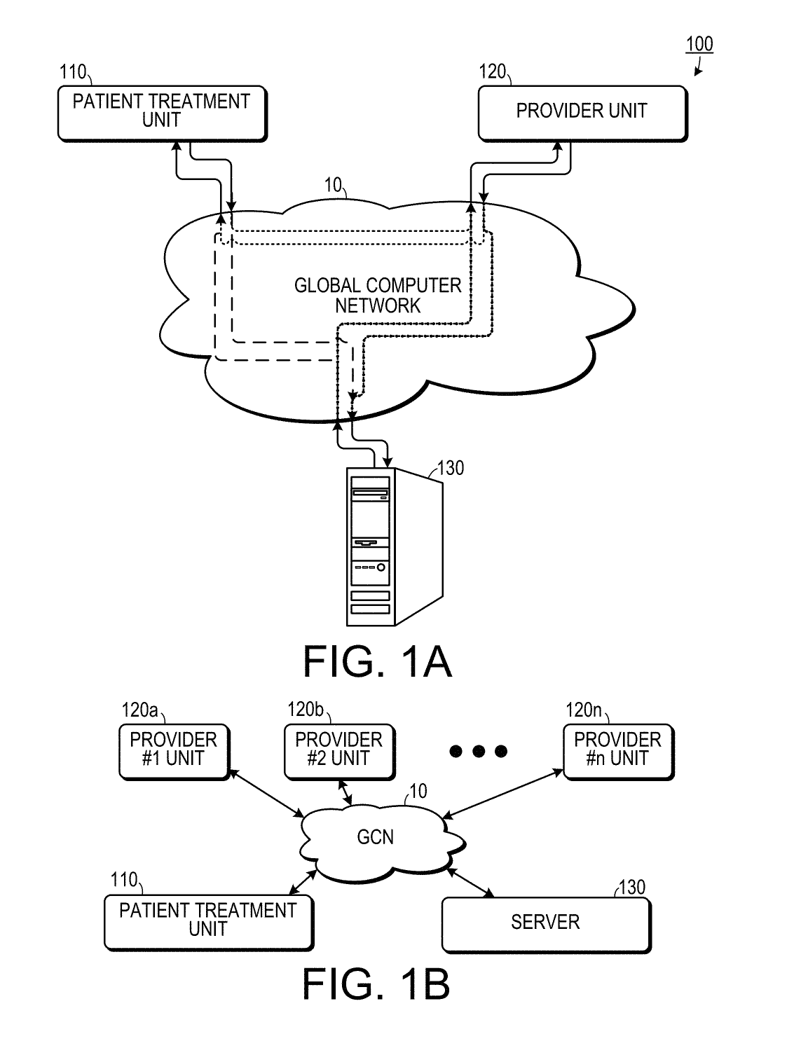

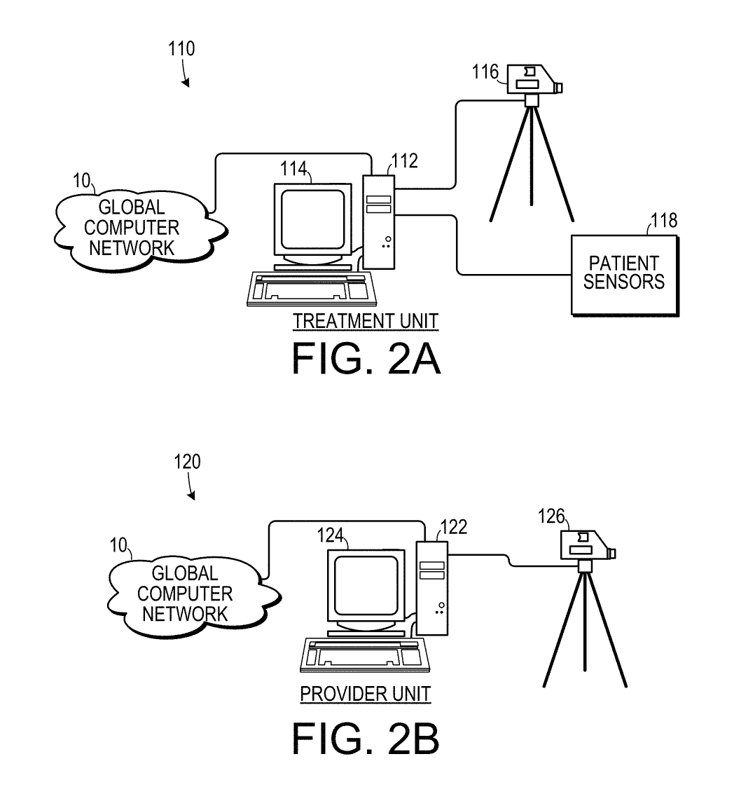

As shown in FIG. 1A, in one embodiment of a telemedicine system 100, a patient treatment unit 110, a first provider unit 120 and a server 130 are all configured to communicate with each other through the global computer network 10 using a peer-to-peer (P2P) communication protocol, such as WebRTC. WebRTC is a standard application programming interface drafted by the World Wide Web Consortium (W3C) that supports browser-to-browser applications for voice calling, video chat and P2P file sharing without the need of either internal or external plugins. Using this protocol, the patient treatment unit 110 can communicate directly with the provider unit 120 without routing communications through the server 130. While information is transmitted directly between the patient treatment unit 110 and the provider unit 120, it is copied to the server 130 for future use and reference.

As shown in FIG. 1B, in one embodiment, the telemedicine system can include several different provider units 120a-n (such as a first provider unit 120a, a second provider unit 120b, etc.) that are remote from each other and that can communicate with the patient treatment unit 110. All data from the patient treatment unit 110 will be communicated to each of the provider units 120a-n via the P2P protocol and each of the provider units 120a-n will have access to data stored on the server 130. With this configuration, several different physicians or other providers can collaborate in treating a patient. A provider can be anyone who would provide treatment to the patient, such as a physician, a physician's assistant, a physical therapist, an occupational therapist, a nurse, etc.

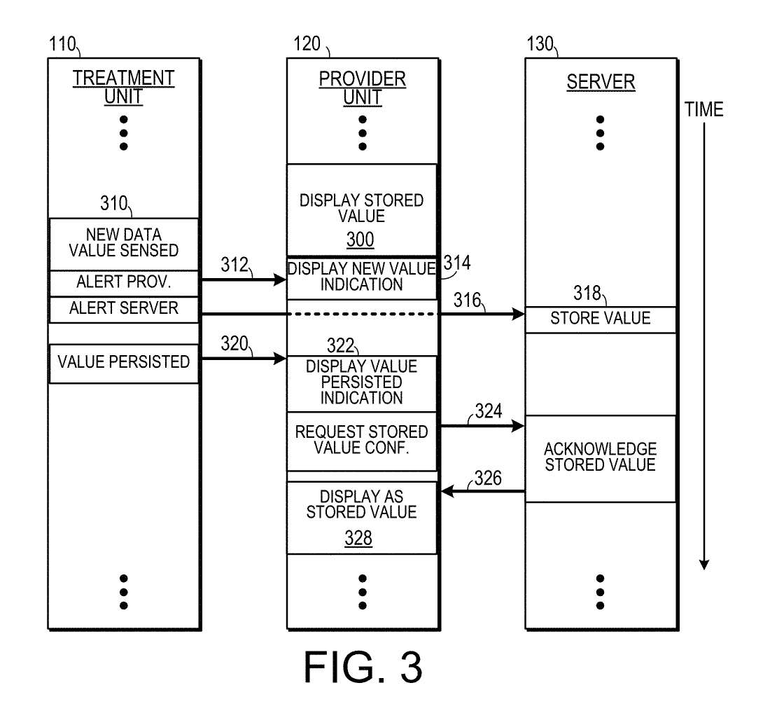

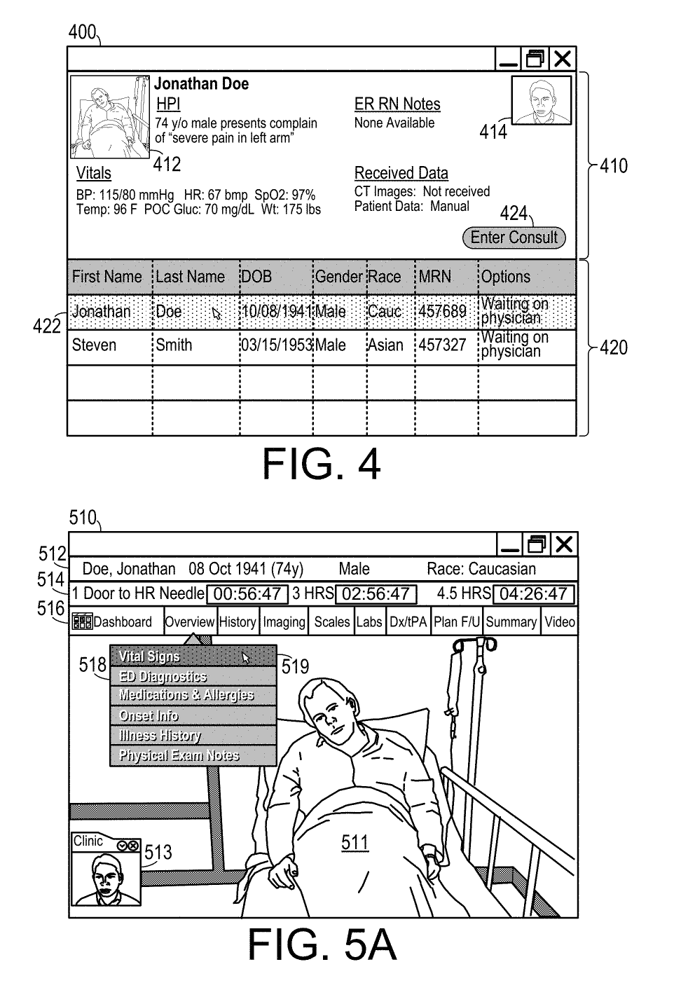

As shown in FIG. 2A, the typical treatment unit 110 will include a computer system 112 with a video monitor 114 (such as a touch screen monitor, which provides both video output and a user input interface) that is in communication with the global computer network 10. A video/audio unit 116 will be in data communication with the computer system 112 and will be aimed at the patient. Patient sensors 118 (for example, vital signs sensors) will be coupled to the patient and will provide data about the patient to the computer system 112. Patient sensors can include, for example, temperature sensors, respiration sensors, pulse sensors, glucose sensors, EKG, EEG, etc. Typically, a health care professional will be at the patient treatment unit 110 with the patient, both to administer treatments and to assist the provider in examining the patient.

As shown in FIG. 2B, the typical provider unit 120 will include a computer system 122 with a monitor 124 (such as a touch screen monitor for both video output and user input) that is in communication with the global computer network 10. A video/audio unit 126 will be in data communication with the computer system 112 and can be used to provide video of the provider to the patient. In some embodiments, a provider can provide control input to the audio/video unit 116 at the patient treatment unit 110 (in FIG. 2A) to allow the provider to focus and zoom the camera on desired parts of the patient.

Employing this system, the provider will be able to see and hear the patient through the transmission of video and audio from the patient to the provider. The patient will also be able to see and hear the provider through the transmission of video and audio from the provider and the patient.

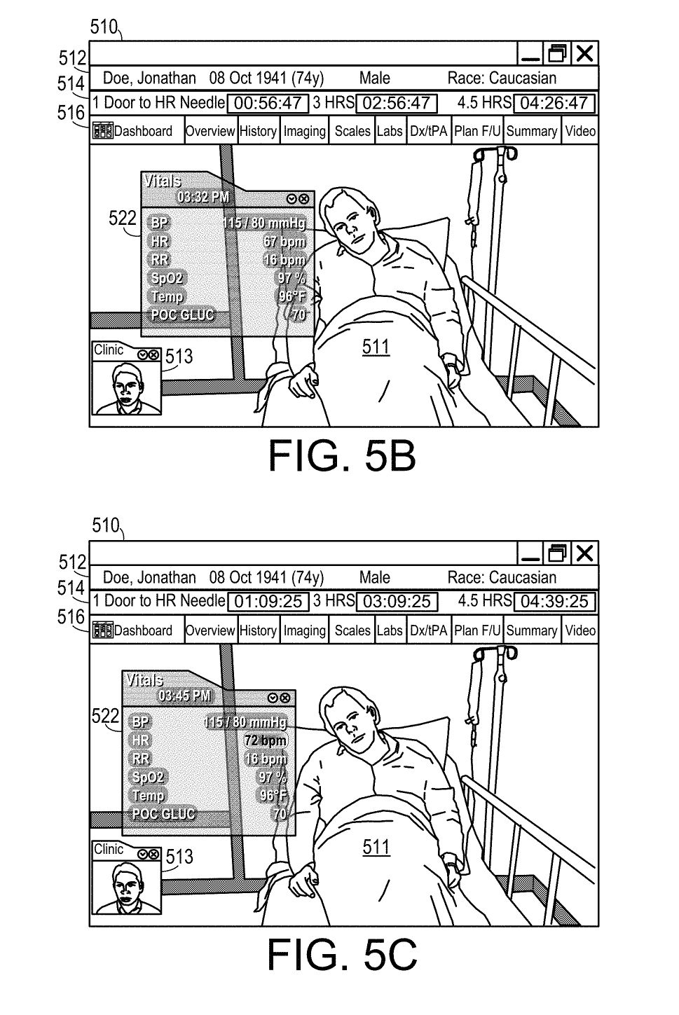

In the data communication protocol, as shown in FIG. 3, a data value (a datum) that has been stored on the server is displayed 300 on the provider unit 120 monitor as a stored value. When a new data value (an updated value of the datum) is sensed 310 (e.g., when the patient's blood pressure changes), the treatment unit 110 computer alerts the provider by sending 312 the new data value to each of the provider units via the peer-to-peer protocol. If the particular parameter associated with the new data value is currently being displayed by a provider unit 120, then the updated displayed value is displayed with an indication that it is a new value 314. The computer at the treatment unit 110 also alerts the server 130 of the new data value by sending it to the server 130. The server 130 then stores 318 the new updated value on a computer-readable memory, such as in a database that associates the new value with a time stamp. Typically, the data will be stored on a non-volatile memory for archival purposes. Once the treatment unit 110 computer determines that the new data value has persisted, it sends a persisted data indication 320 to the provider unit 120 via the peer-to-peer communication protocol, which indicates that the value has been sent to the server 130. The computer at the provider unit 120 then displays the value with an indication that it is a persisted value 322. The provider unit 120 computer then transmits a request 324 to the server 130 for an acknowledgement that the new data value has been stored by the server 130. In response, the server 130 transmits a stored value confirmation 326 to the provider unit 120 computer, which then displays the value with an indication that it is a stored value 328.

When several different provider units (such as sites 120a-n shown in FIG. 1B) participate in a consultation simultaneously, then all data transmitted from the treatment unit 110 will be sent to all of the participating provider units 120a-n through this P2P protocol. Each provider will have the ability to select which parameters are to be displayed on that provider's monitor. For example, provider 120a might find displaying the patient's blood pressure useful, whereas provider 120b might not. In this case, data updates for the patient's blood pressure will be sent to both provider units, but will be displayed only on provider 120a's monitor.

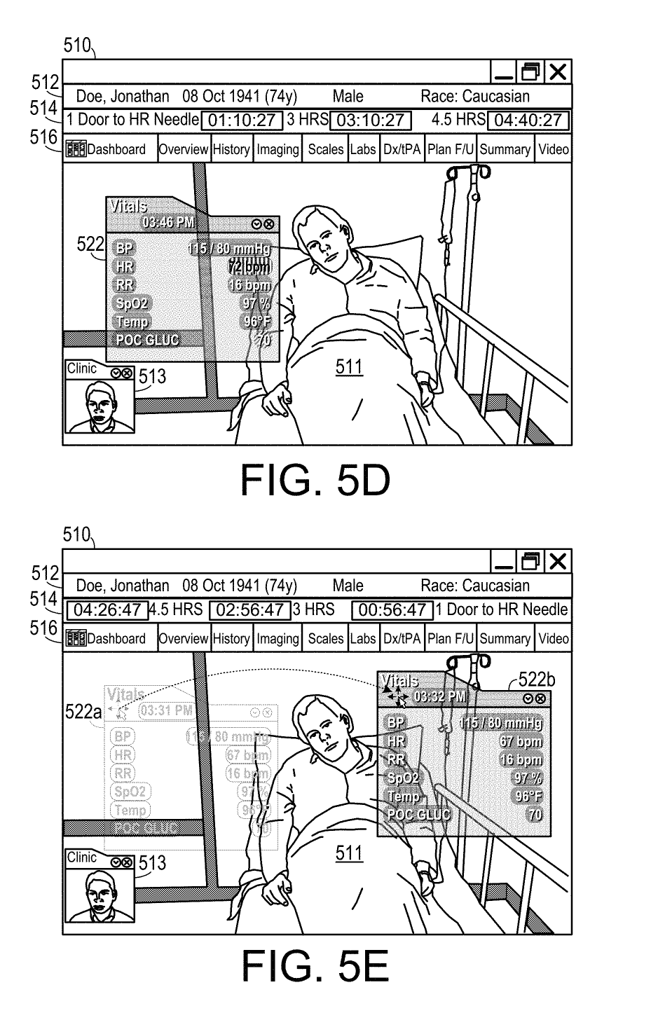

As shown in FIG. 4, the provider is initially presented with an available patient display 400 in browser interface. (Examples of suitable browsers include Windows Internet Explorer, Modzilla Firefox, Google Chrome, etc.) The display 400 may include a summary portion 420 that lists the names of patients awaiting a consult and various information items about them. The provider can select one of the patients with either a mouse or by touching the patient entry through a touch screen interface. Once the provider selects a patient (such as patient 422, as shown), the line for the selected patient is highlighted and a patient data display portion 410 displays important information about the patient (which could include, for example, a description of the patient's symptoms, vital signs and information regarding other patient data that is available). The patient data display portion 410 could also include current video of the patient 412 and even a copy of the video being sent from the provider to the patient 414. If the provider decides to start a consultation with the patient, then the consultation is started by touching or clicking on an “Enter Consult” button 424.

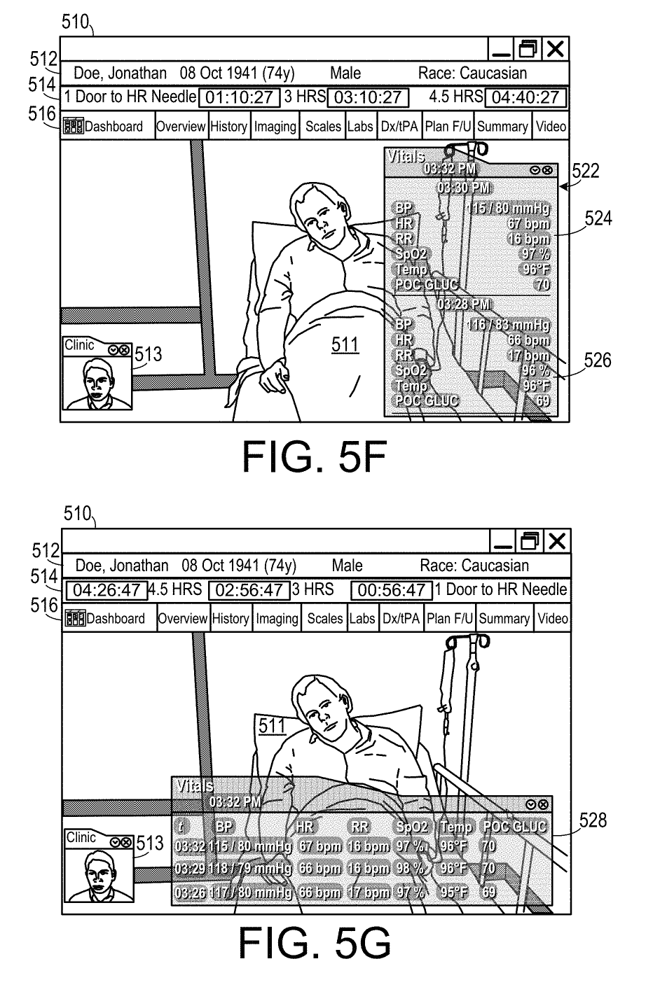

Once the consultation has begun, as shown in FIG. 5A, the provider is shown a screen 510 in the browser that includes patient video 511, video of the provider 513 (which is also transmitted to the patient), patient background information 512, timing data 514 regarding how much time has passed since certain important events have occurred and how much time is left until certain timing milestones are reached. Also, a subject menu 516 is presented to the provider. The subject menu allows the provider to select the types of clinical widgets that the provider wants to be displayed with the patient video 511. For example, the provider might select “Overview,” which opens a pull-down menu 518 that lists a series of widgets that provide categories of information about the patient. In the example shown, the provider has selected the “Vital Signs” entry 519 to be displayed.

Selecting this entry, as shown in FIG. 5B, causes the provider computer to superimpose a widget 522 (in the example shown, a “vital signs” widget) on the patient video 511. Each widget displays information that is useful to the provider. For example, the vital signs widget 522 shown includes current data values for the patient parameters, such as: blood pressure (BP), heart rate (HR), respiration rate (RR), peripheral oxygen saturation (SpO2); temperature (Temp) and blood glucose concentration (POC GLUC). The widget 522 is semi-transparent or translucent, in that is allows the patient video image to be seen through the widget 522. Each parameter label and corresponding data value is shown so as to contrast with any background color or shade appearing in the patient video 511 so as to be visually perceptible irrespective of the video over which the widget is overlaid. This can be done, for example, by showing the label and data value with two contrasting shadow images or a darkened local background.

When a data value has been stored on the server 130, it will be displayed in a visually perceptible manner that indicates that it is a stored data value, such as the data values that are shown in the widget 522 in FIG. 5B. When a new value for a parameter is received from the patient treatment unit computer, it is shown in a visually perceptible manner that indicates that it is a new value. For example, as shown in FIG. 5C, when the heart rate (HR) changes from 67 bpm (as shown in FIG. 5B) to 72 bpm (as shown in FIG. 5C), it is shown with a color and a background that are different from the color and background used for the previously stored value. Once the patient treatment unit computer indicates that the value has persisted, as shown in FIG. 5D, the value is shown in yet a different visually perceptible manner. Once a confirmation has been received from the server, the value will again be displayed with the stored value scheme.

As shown in FIG. 5E, the widget 522a can be moved across the screen from a starting location to a different desired location for the widget 522b. This can be accomplished when the provider touches a touch screen with his or her finger and moves the finger to indicate the desired new location of the widget 522b, or by clicking and dragging it with a mouse. In this way, the provider can optimize placement of the widget and adapt the display to changing circumstances by dragging it to a desired position on in the display.

As shown in FIG. 5F, a provider can vertically expand, or re-size, the widget 522 to a desired size, which can show several different sets of data to show the data values of parameters at different time periods. In the example shown, the provider has chosen to display the vital signs for a first time 524 and a previous time 526. The provider can use this functionality to scroll through all of the data recorded by the system. Scrolling input can be accomplished by touching the widget 522 on a touch screen and dragging the values upward or downward. It could also be accomplished with a user input device such as a wheel mouse, a track ball, a joy stick, etc.

As shown in FIG. 5G, if the provider prefers a table format, the provider can change the orientation of the widget 528 to a landscape configuration. This configuration allows data values taken at different times (t) to be displayed in table format. Again, in this configuration, the provider can scroll down to view recent historical data.

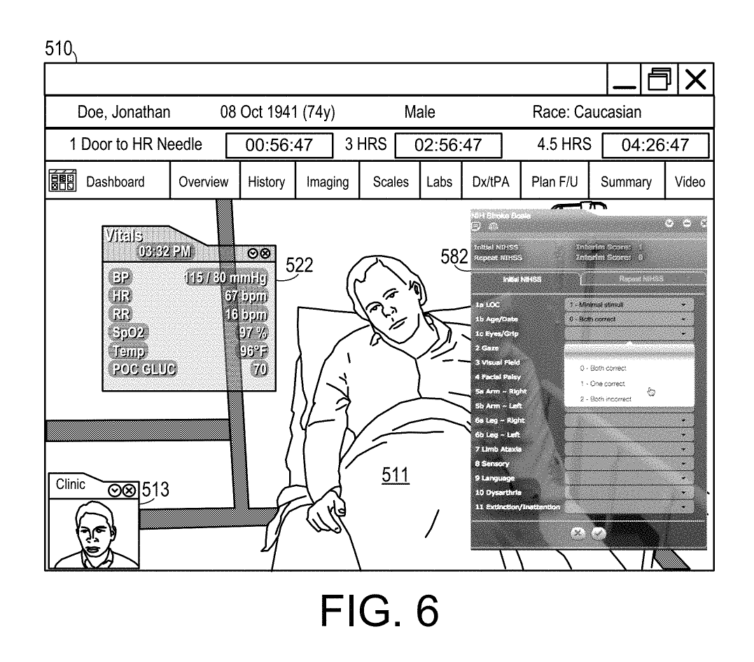

More than one widget can be displayed simultaneously, as shown in FIG. 6, in which the provider has selected both a vital signs widget 522 and an interactive widget 582. In this case, the interactive widget 582 presents a plurality of preset input values for several parameters relative to strokes that can be selected from pull-down menus. The provider can select values in this diagnostic scoring test based on observations of the patient and the widget will generate a “score” indicating the likelihood of a particular diagnosis that can aid the provider in making a diagnosis based on predetermined criteria.

The system can include a library of different practice-specific clinical widgets for displaying clinical data to the provider. A specific widget can be defined for each key aspect of a remote consultation. They provide the ability to view and update current values and also view prior values for monitoring changes. As an example, a vital signs widget could include the following parameters: Blood Pressure, Heart Rate, Respiratory Rate, Blood Oxygen Saturation, Weight, Temperature, Blood Glucose, etc. As another example, a urology widget could include parameters such as: Fluid Consumption, Urine Output, Urine Color, Peak Renal Systolic Arterial Velocity, etc. Essentially, any configuration for a widget can be generated to facilitate the needs of a specific practice type or a provider preference.

Custom clinical widgets can also be made to meet the specific needs or preferences of a given provider. Additionally, a provider can have the ability to change parameter labels on a widget. For example, one provider might prefer temperature to be referred to a “Temp” while another provider might prefer “T.” This can be accomplished locally by the provider selecting the parameter and invoking a “rename” function. Additionally, a provider can select between different unit standards (e.g., degrees Fahrenheit or degrees Celsius) and the widget will calculate the parameter values according to the desired standard.

Clinical widgets can have certain significant features. They can retain their state no matter if they are closed, minimized, re-opened, etc. A user can “Save” the position he or she placed each clinical widget so that subsequent sessions will automatically load and place each widget on the screen where the user previously placed them. Specified field labels can be renamed at the clinical data level without disturbing the underlying meaning of the data. Units of measurement can be customized for specific clinical data types. Clinical data fields can be “removed” or hidden as part of a widget configuration according to the user's preferences. Custom data fields can also be added to a widget. Role-based workflows are built in to clinical widgets. For example, a tPA widget can dynamically change its interface and options based on the user type as well as the state of interaction between the treatment unit and the provider unit(s). The same code base and software supports both desktop and mobile environments, including support for touch screen-based interaction while keeping the user experience the same regardless of the device.

The clinical widgets can have the attributes including: they are translucent so that the video image is present and visible to the user; they are movable—the user can move the widget to any location on the screen by activating the mouse on top of the widget; the widget's information is made legible over any video background by using two shadows around each character (letter, number, etc.); the widget can be minimized and brought forth on the screen; the widget may be converted to a horizontal view; the widget includes unit of measure conversion capability (pounds-to-kilograms, Fahrenheit-to-Celsius, etc.); the widget can change the color of information when the information is updated by another widget's input via the data channel; the widget may contain data and application logic; the widget may be modified by the user to add, change or delete fields. The fields may have edit capabilities—i.e. to accept only valid ranges or to select on from a valid list and the widget enables collaboration by using a data channel to send information from one widget to another via the internet.

Clinical widgets support several functions, including: serving as the building blocks that allow healthcare organizations to select the right or best or appropriate tools available for each clinical specialty and standardize treatment protocols for each specialty and care setting; allowing physicians or other providers to tailor each consultation based on personal preferences and the information specific to their specialty; guiding the treatment workflow for both bedside clinicians and remote physicians; fostering collaboration among the treatment team members—each team member can review updates as they are entered by other team members; providing warnings and highlight contraindications when exceptions to treatment protocols are encountered; providing a collection point for external data such as patient data retrieved from the EMR and/or ADT feed, and images from the PACS system; and serving as the source of documentation for each consultation.

Clinical widgets can be selected and made available based on service lines or specialties supported. Widgets can also be configured to align with the standard treatment protocols of a specific healthcare organization. Individual data elements can be reordered, removed or added, and default units of measure, such as metric vs imperial, can be specified.

Widgets can be selected or excluded by the provider to tailor each exam based on the symptoms, diagnosis and treatment plan of the patient. A physician may utilize common widgets such as Vitals, Patient History and Labs in every consultation and also include disease-specific or specialty-specific widgets such as the Mini-Mental State Exam and Glasgow Coma Scale widgets for psychiatric assessments or the NIH Stroke Scale and tPA Administration widgets for stroke cases. If a patient is initially diagnosed with a condition such as a stroke, but is later determined to be suffering from another neurological disorder such as aphasia, the physician can cease using the stroke widgets and add neuro widgets such as the Miami Emergency Neuro Deficit Scale Score (MEND) widget as appropriate. The resulting consult report and data uploaded to the EMR will include information from all the relevant widgets used in the consultation.

Visually, the widgets can be designed by clinical experts to maximize focus on the patient. Rather than forcing the physician to access data in a separate application (typically on a separate screen), widgets are displayed on the same screen as the patient. They are semi-transparent/translucent, enabling a constant full-screen view of the patient. They are easily repositioned and minimized to suit the individual preference of each physician. The orientation of widgets can also be adjusted during the consultation to provide different perspectives of the data. For example, the vertical perspective may be preferred for viewing and updating the most current values while the horizontal perspective provides an at-a-glance view of changes over time.

A datum can be updated through new input from a patient sensor or it can be input manually by a provider or other user. As data are updated by bedside clinicians or the remote physician, the updates are highlighted for each team member participating in the consultation. Additionally, each physician can specify which widgets are displayed initially when he or she joins a consultation.

The system can be entirely web-based and accessed in an Internet browser. Through a secure login, providers can conduct remote consultations from any location using a variety of devices including desktop computers, laptops, smart phones, and tablets.

The system internally tracks and manages each participant's clinical data updates based on the following: the widget configuration; the participant's role in the consultation; the state of the clinical data (i.e., whether it is transient, persisted or stored); and the specific type of clinical data (i.e., field-level identification).

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A telemedicine system, comprising:
(a) a patient treatment unit, including: a patient treatment computer in communication with a global computer network; a video camera in communication with the patient treatment computer; a patient sensor interface in communication with the patient treatment computer in which the patient sensor interface is configured to receive data from at least one patient sensor; a microphone in communication with the patient treatment computer; and a speaker in communication with the patient treatment computer;
(b) a first provider unit that is in a location remote from the patient treatment unit, including: a provider computer in communication with the global computer network; at least one microphone in communication with the provider computer; and a monitor in communication with the provider computer;
(c) a server in communication with the global computer network;
(d) an application interface configured to effect a peer-to-peer communication protocol between the patient treatment computer and the provider computer via the global computer network, in which patient video from the patient treatment unit is transferred to the first provider unit via the peer-to-peer communication protocol and displayed on the first provider unit monitor, and wherein data from the patient sensor interface is also transferred to the first provider unit via the peer-to-peer communication protocol, the application interface also configured to display a widget on the first provider unit monitor so as to be superimposed on the patient video so as to be semitransparent such that a portion of the patient video is viewable through a portion of the widget and such that at least one data value displayed in the widget visually contrast with the portion of the patient video under the widget wherein the widget includes patient-specific information and in which the application interface is configured to transmit the data from the patient treatment computer to the server for storage by the server.

2. The telemedicine system of claim 1, further comprising a second provider unit that is in a location remote from the patient treatment unit and from the first provider unit, including: a provider computer in communication with the global computer network; at least one microphone in communication with the provider computer; and a monitor in communication with the provider computer, wherein the application interface is further configured to effect a peer-to-peer communication protocol between the patient treatment computer and the provider computer of the second provider unit via the global computer network, in which patient video from the patient treatment unit is transferred to the second provider unit via the peer-to-peer communication protocol and displayed on the second provider unit monitor, and wherein data from the patient sensor interface is also transferred to the second provider unit via the peer-to-peer communication protocol.

3. The telemedicine system of claim 1, wherein the widget displays at least one datum received from a selected one of the patient sensor interface and a manual user input.

4. The telemedicine system of claim 3, wherein when an updated value of the datum is sensed by the patient sensor interface or received from a manual user input, the application interface is configured to;
(a) transmit the updated value from the patient treatment unit to the first provider unit via the peer-to-peer communication protocol;
(b) transmit the updated value from the patient treatment unit to the first provider unit via the peer-to-peer communication protocol;
(c) after transmitting the updated value to the first provider unit, transmit the updated value from the patient treatment unit to the server;
(d) store the updated value on the server;
(e) transmit a persisted data indication from the patient treatment unit to the first provider unit via the peer-to-peer communication protocol, indicating that the updated value has been transmitted to the server;
(f) transmit a persisted data confirmation request from the first provider unit to the server; and
(g) once the updated value has been stored by the server, transmitting a confirmation in response to the confirmation request from the server to the first provider unit indicating that the updated value has been stored on the server.

5. The telemedicine system of claim 4, wherein the application interface is further configured to:
(a) display the datum on the widget in a first visually perceptible manner when the updated value of the datum is received by the first provider unit from the patient treatment unit;
(b) display the datum on the widget in a second visually perceptible manner, different from the first visually perceptible manner, when the persisted data indication is received by the first provider unit from the patient treatment unit; and
(c) display the datum on the widget in a third visually perceptible manner, different from the first visually perceptible manner and the second visually perceptible manner, when the confirmation in response to the confirmation request has been received by the first provider unit from the server.

6. The telemedicine system of claim 1, wherein a patient sensor interface is configured to receive vital signs from the patient and wherein the widget displays the vital signs from the patient.

7. The telemedicine system of claim 1, wherein the widget displays a diagnostic scoring test that allows input of values for a plurality of parameters relevant to a predetermined diagnosis.

8. The telemedicine system of claim 7, wherein the system generates a diagnostic score corresponding to the likelihood of the predetermined diagnosis based on the values for a plurality of parameters input by a user.

9. The telemedicine system of claim 7, wherein the widget includes a pull-down menu corresponding to at least one of the parameters and wherein the pull-down menu presents a plurality of different preset values for the at least one of the parameters and wherein the system allows selection of one of the plurality of different preset values through a user interface.

10. The telemedicine system of claim 1, wherein the application interface is further configured to:
(a) receive input from the first provider unit indicating a desired position for the widget on the monitor; and
(b) to move the widget to the desired position.

11. The telemedicine system of claim 1, wherein the application interface is further configured to receive input from the first provider unit indicating a desired size for the widget and to re-size the widget to the desired size.

12. The telemedicine system of claim 1, wherein the application interface is further configured to display at least two different sets of data on the widget in which the at least two sets of data correspond to data sensed during at least two different periods.

13. The telemedicine system of claim 12, wherein the application interface is further configured to receive a scrolling input from a user and to cause sets of data selected from a plurality of different periods to be displayed on the widget.

14. A method of displaying information in a telemedicine system that communicates information between a patient treatment unit, a server and a first provider unit having a monitor, comprising the steps of:
(a) receiving video and patient-specific data from the patient treatment unit at the first provider unit;
(b) displaying the video on the first provider unit monitor; and
(c) displaying the patient-specific data in a semi-transparent widget that overlays the video so that the video can be seen through at least a portion of the semi-transparent widget.

15. The method of claim 14, further comprising the steps of:
(a) displaying at least one datum of the patient-specific data in a semi-transparent widget in a first manner when the at least one datum has been received from the patient treatment unit by the first provider unit;
(b) displaying the at least one datum of the patient-specific data in a semi-transparent widget in a second manner, different from the first manner, after the at least one datum has been transmitted from the patient treatment unit to the server; and
(c) displaying the at least one datum of the patient-specific data in a semi-transparent widget in a third manner, different from the second manner and from the first manner, after the first provider unit has received a confirmation from the server that the at least one datum has been stored by the server.

16. The method of claim 14, further comprising the step of displaying the patient-specific data in a manner that is visually perceptible irrespective of the video over which the widget is overlaid.

17. A method for communicating data in a telemedicine system that includes a patient treatment unit in communication with a global computer network, a provider unit in communication with the global computer network and a server in communication with the global computer network, the method comprising the steps of:
(a) transmitting a patient-specific datum from the patient treatment unit to the provider unit via a peer-to-peer protocol;
(b) after transmitting the patient-specific datum to the provider unit, transmitting the patient-specific datum to the server;
(c) after transmitting the patient-specific datum to the server, storing the patient-specific datum at the server and transmitting a persisted data indicator from the patient treatment unit to the provider unit via the peer-to-peer protocol;
(d) after the first provider unit receives the persisted data indicator, transmitting a stored data request from the provider unit to the server; and
(e) after the patient-specific datum has been stored by the server, transmitting a stored data confirmation from the server to the provider unit and displaying the datum with a stored data indicia on the display at the provider unit.

18. The method of claim 17 further comprising the steps of:
(a) displaying the patient-specific datum with a new data indicia on a display at the provider unit after the step of transmitting a patient-specific datum from the patient treatment unit to the provider unit;
(b) displaying the datum with a persisted data indicia on the display at the provider unit after the step of after transmitting the patient-specific datum to the server; and
(c) displaying the datum with a stored data indicia on the display at the provider unit after the patient-specific datum has been stored by the server.

19. The method of claim 17 further comprising the steps of:
(a) transmitting video from the patient treatment unit to the provider unit;
(b) displaying the video on a video display at the provider unit; and
(c) displaying the datum in a widget that overlays at least a portion of the video on the video display.

20. The method of claim 19, further comprising the step of generating display data that is displayed on the video display so has to include the video and the widget so that at least a portion of the widget appears to be translucent and overlaid on the video.

21. The method of claim 17, further comprising the steps of:
(a) transmitting first audio data from the patient treatment unit to the provider unit and playing sounds corresponding to the first audio data at the provider unit; and
(b) transmitting second audio data from the provider unit to the patient treatment unit and playing sounds corresponding to the second audio data at the patient treatment unit.
